(19) United States
(12) Patent Application Publication
(10) Pub. No.: US 2026/0073237 A1
(43) Pub. Date: Mar. 12, 2026

(54) Quantization-Based Method and System for Federated Fine-Tuning a Pre-Trained Large Language Model

(71) Applicant: City University of Hong Kong, Hong Kong (HK)

(72) Inventors: Dapeng WU, Hong Kong (HK); Hong HUANG, Hong Kong (HK)

(21) Appl. No.: 18/826,231

(22) Filed: Sep. 6, 2024

(51) Int. Cl. G06N 3/098; G06N 3/0495

(52) U.S. Cl. CPC G06N 3/098; G06N 3/0495

(57) ABSTRACT

The present invention provides a quantization-based method and system for federated fine-tuning a pre-trained large language model (LLM). The system comprises an accelerator configured to identify outlier channels of the LLM and inject a set of adapters into the LLM; and local devices configured to: construct channel-wise scaling vectors on basis of the indices of the identified outlier channels; apply the channel-wise scaling vectors on input matrices of the LLM to obtain scaled activation matrices; quantize the scaled activation matrices to obtain quantized activation matrices; apply the channel-wise scaling vectors on the outlier weight matrices of the LLM to obtain scaled outlier weight matrices; quantize the scaled outlier weight matrices to obtain quantized outlier weight matrices; fine-tune the adapters of the LLM with the quantized activation matrices and the quantized outlier weight matrices. The server is further configured to perform weight aggregation to produce new adapters for the LLM.

### FIELD OF THE INVENTION

The present invention generally relates to artificial intelligence, and more specifically relates to a quantization-based method and system for federated fine-tuning a pre-trained large language model (LLM).

### BACKGROUND OF THE INVENTION

LLMs are excelling in a wide array of applications such as essay writing, poetry composition, and conversational engagement with their remarkable capabilities. However, due to the substantial computational resources required for fine-tuning LLMs on specialized tasks, it remains a significant challenge for ordinary users and businesses to customize their LLMs to specific tasks on personal devices with confidential data due to the substantial computational resources. For instance, the Llama 2 model (Touvron et al., 2023), with its extensive network of 6.7 billion parameters, requires an 80 GB A 100 GPU for fine-tuning, presenting a formidable barrier to individual and small-scale enterprise utilization.

Quantization is an approach that has shown great and consistent success in improving efficiency in both training and inference of neural network (NN) models. In particular, the breakthroughs of half-precision and mixed-precision training have been the main drivers that have enabled an order of magnitude higher throughput in AI accelerators. Transitioning from floating-point to more efficient fixed-point operations necessitates an acceleration systemology for transforming floating-point vectors into integer representations. This acceleration systemology is also known as a quantization scheme. However, existing quantization systems or schemes face challenges that make them less efficient for fine-tuning tasks in LLMs, especially under federated learning scenarios, where the resource-constrained devices collaboratively train a model with their data for privacy concerns. The main problem is the significant noise from quantization during fine-tuning, which can lead to a significant decrease in model accuracy. Moreover, the resource-constrained local devices have strict energy and memory requirements, making most quantization schemes difficult to deploy because they require computation-intensive full-precision training before quantization. Additionally, most current deep learning frameworks such as PyTorch and TensorFlow lack support for low-precision matrix multiplication on GPUs. This flaw not only hinders speedup but can also cause efficiency degradation compared to full-precision operations, primarily due to the overhead associated with data type conversions.

### SUMMARY OF THE INVENTION

It is one objective of the present disclosure to address the aforementioned shortcomings by providing a federated quantization-aware system to facilitate the fine-tuning of LLMs in low precision without the risk of leaking confidential data.

In accordance with the first aspect of the present invention, a quantization-based method for federated fine-tuning a pre-trained large language model with a server and one or more devices is provided. The method comprises: (a) freezing, by the server, all weight matrices of the pre-trained language model; (b) identifying, by the server, one or more outlier channels from a plurality of channels of the large language model on basis of public datasets; (c) extracting, by the server, outlier weight matrices on basis of indices of the identified outlier channels from the frozen weight matrices of the pre-trained language model; (d) quantizing, by the server, the frozen weight matrices of the pre-trained large language model; (e) injecting, by the server, a set of adapters into the pre-trained language model; (f) downloading, by each device, the quantized weight matrices of the pre-trained large language model, the outlier weight matrices of the pre-trained large language model and the indices of the identified outlier channels from the server; (g) downloading, by each device, the adapters of the pre-trained large language model; (h) constructing, by each device, channel-wise scaling vectors on basis of the indices of the identified outlier channels; (i) applying, by each device, the channel-wise scaling vectors on input matrices of the pre-trained large language model to obtain scaled activation matrices; (j) quantizing, by each device, the scaled activation matrices to obtain quantized activation matrices; (k) applying, by each device, the channel-wise scaling vectors on the outlier weight matrices of the pre-trained large language model to obtain scaled outlier weight matrices; (l) quantizing, by each device, the scaled outlier weight matrices to obtain quantized outlier weight matrices; (m) fine-tuning, by each device, the adapters of the large language model with the quantized activation matrices and the quantized outlier weight matrices; (n) uploading, by each device, the adapters of the large language model to the server; (o) performing, by the server, weight aggregation to produce new adapters for the large language model; and (p) repeating steps (g) to (o) until a stop criterion is met.

In accordance with a second aspect of the present invention, a quantization-based system for federated fine-tuning a pre-trained large language model is provided. The system comprises: a memory configured to store the large language model and input matrices; an accelerator configured to: freeze all weight matrices of the pre-trained language model; identify one or more outlier channels from a plurality of channels of the large language model on basis of public datasets; extract outlier weight matrices on basis of indices of the identified outlier channels from the frozen weight matrices of the pre-trained language model; quantize the frozen weight matrices of the pre-trained large language model; and inject a set of adapters into the pre-trained language model; and one or more local devices, each device is configured to: download the quantized weight matrices of the pre-trained large language model, outlier weight matrices of the pre-trained large language model, the adapters of the pre-trained large language model and the indices of the identified outlier channels from the server; construct channel-wise scaling vectors on basis of the indices of the identified outlier channels; apply the channel-wise scaling vectors on input matrices of the pre-trained large language model to obtain scaled activation matrices; quantize the scaled activation matrices to obtain quantized activation matrices; apply the channel-wise scaling vectors on the outlier weight matrices of the pre-trained large language model to obtain scaled outlier weight matrices; quantize the scaled outlier weight matrices to obtain quantized outlier weight matrices; fine-tune the adapters of the large language model with the quantized activation matrices and the quantized outlier weight matrices; and upload the adapters of the large language model to the server. The server is further configured to perform weight aggregation to produce new adapters for the large language model.

The current innovation effectively reduces memory and computing resources required for floating point operations and significantly lowers the computational burden. Remarkably, the precision optimization approach provided by the present invention preserves the integrity and accuracy of the fine-tuning processing, ensuring that the fine-tuned LLMs retain their efficacy when applied to downstream tasks, enabling users to customize their own LLMs on common personal devices such as PCs, laptops, and even mobile phones, making it feasible for a broader audience to harness the power of LLMs for their unique applications without exposing the data and without the need for specialized, expensive hardware.

The present invention enables impressive gains in efficiency, achieving up to eight times faster processing speeds and equivalent reductions in memory usage during fine-tuning of LLMs. This breakthrough not only heralds significant cost efficiencies but also extends the accessibility of advanced language modeling capabilities to a wider array of users, particularly those constrained by limited computational infrastructure.

### BRIEF DESCRIPTION OF DRAWINGS

Embodiments of the invention are described in more detail hereinafter with reference to the drawings, in which:

FIGS. 1A to 1C show a process flowchart of a quantization-based method for federated fine-tuning a pre-trained LLM in accordance with one embodiment of the present invention.

FIG. 2 shows a block diagram of a quantization-based system for federated fine-tuning a pre-trained LLM in accordance with one embodiment of the present invention.

FIG. 3 shows a framework for federated fine-tuning of a pretrained LLM in various personal devices to perform various tasks.

FIG. 4 shows a schematic overview of a matrix-vector multiplication calculated in a quantization-based acceleration system.

FIG. 5 outlines a transformer block for performing the matrix multiplication operations in accordance with some embodiments of the present invention.

FIG. 6 shows adapters in one layer of LLM.

### DETAILED DESCRIPTION

In the following description, a quantization-based method and system for federated fine-tuning a pre-trained LLM and the likes are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

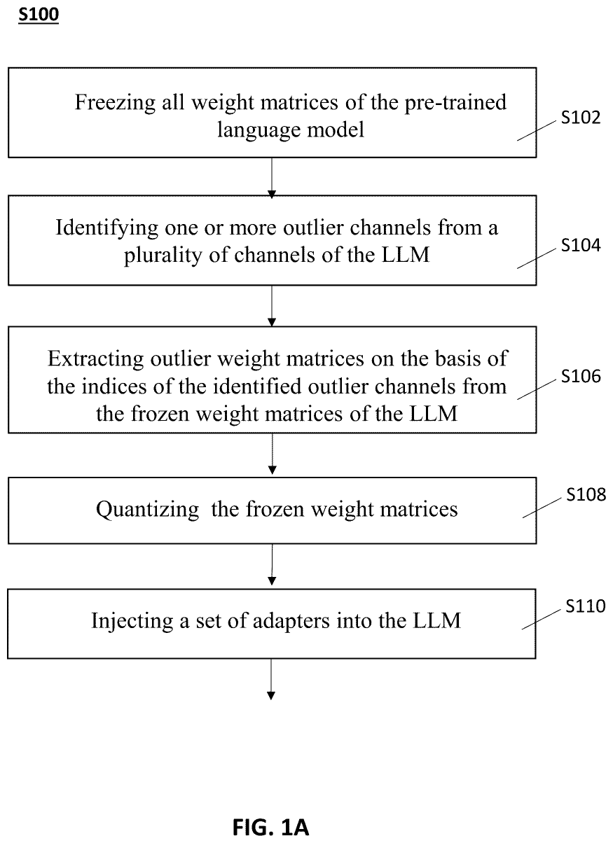

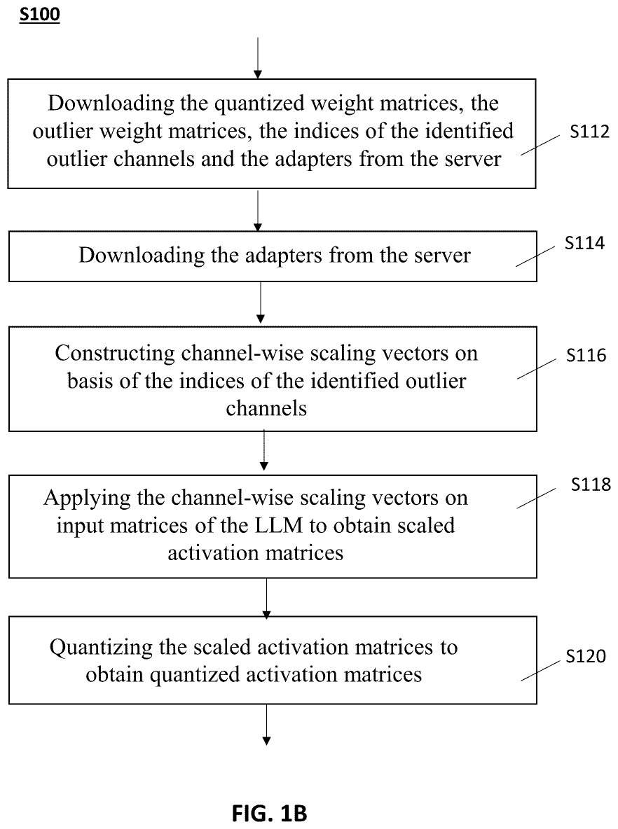

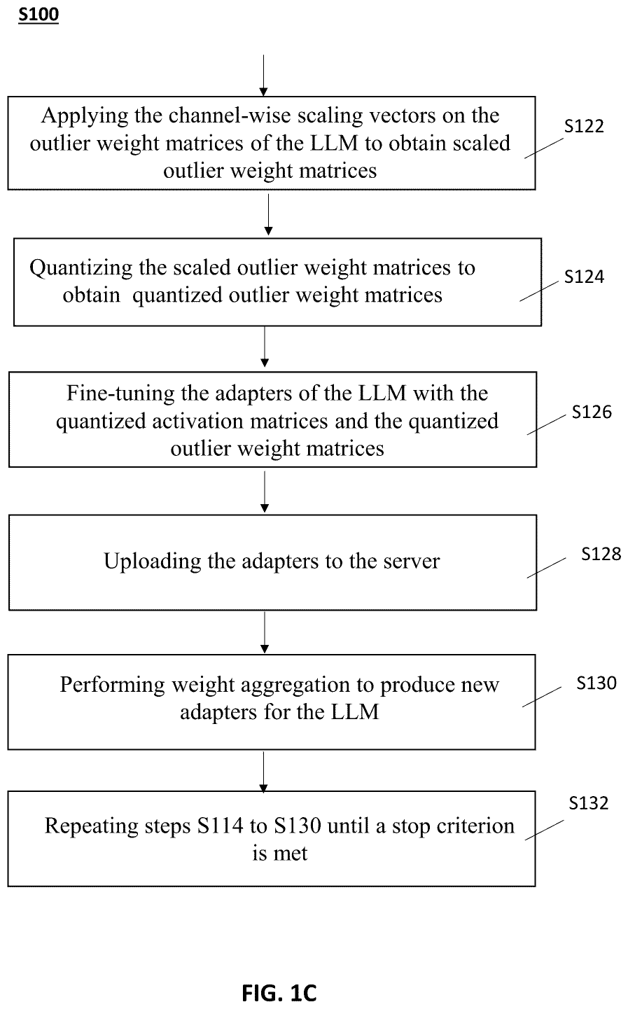

FIGS. 1A to 1C show a process flowchart of a quantization-based method S100 for federated fine-tuning a pre-trained LLM by a server and one or more local devices in accordance with one embodiment of the present invention. The quantization-based method comprises the following steps:
S102: freezing, by the server, all weight matrices of the pre-trained language model;
S104: identifying, by the server, one or more outlier channels from a plurality of channels of the large language model on the basis of public datasets;
S106: extracting, by the server, outlier weight matrices on the basis of indices of the identified outlier channels from the frozen weight matrices of the pre-trained language model;
S108: quantizing, by the server, the frozen weight matrices of the pre-trained large language model;
S110: injecting, by the server, a set of adapters (or trainable parameters) into the pre-trained language model;
S112: downloading, by each device, the quantized weight matrices of the pre-trained large language model, the outlier weight matrices, of the pre-trained large language model and the indices of the identified outlier channels from the server;
S114: downloading, by each device, adapters of the pre-trained large language model;
S116: constructing, by each device, channel-wise scaling vectors on basis of the indices of the identified outlier channels;
S118: applying, by each device, the channel-wise scaling vectors on input matrices of the pre-trained large language model to obtain scaled activation matrices;
S120: quantizing, by each device, the scaled activation matrices to obtain quantized activation matrices;
S122: applying, by each device, the channel-wise scaling vectors on the outlier weight matrices of the pre-trained large language model to obtain scaled outlier weight matrices;
S124: quantizing, by each device, the scaled outlier weight matrices to obtain quantized outlier weight matrices;
S126: fine-tuning, by each device, the adapters of the large language model with the quantized activation matrices and the quantized outlier weight matrices;
S128: uploading, by each device, the adapters of the large language model to the server;
S130: performing, by the server, weight aggregation to produce new adapters for the large language model;
S132: repeating, by each device, steps S114-S130 until a stop criterion is met. The stop criteria may be a predefined number of cycles (e.g., 100 cycles) to be repeated; or a target convergence to be achieved.

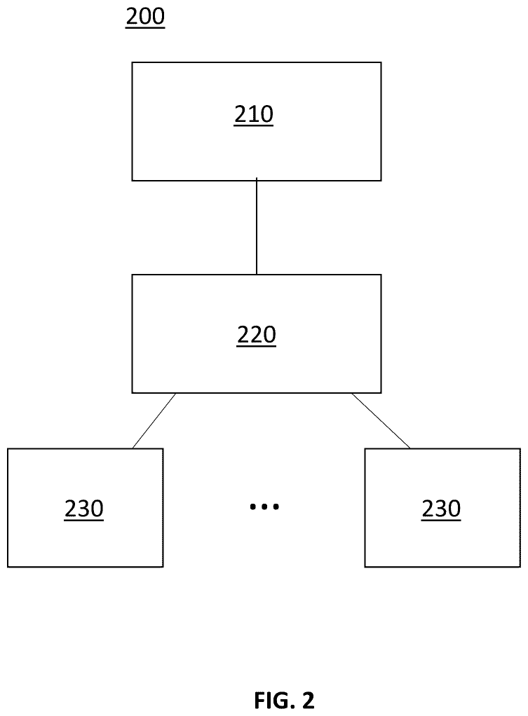

FIG. 2 shows a block diagram of a quantization-based system 200 for federated fine-tuning a pre-trained LLM in accordance with one embodiment of the present invention. The quantization-based federated acceleration system comprises a memory 210 and at least one accelerator (or server) 220 and one or more local devices 230.

The memory 210 is configured to store the LLM and an input matrix. The accelerator 220 is configured to: freeze all weight matrices of the pre-trained language model; identify one or more outlier channels from a plurality of channels of the LLM on the basis of public datasets; extract outlier weight matrices on the basis of indices of the identified outlier channels from the frozen weight matrices of the pre-trained language model; quantize the frozen weight matrices of the pre-trained LLM; and inject a set of adapters into the pre-trained language model.

Each of the one or more local devices 230 is configured to: download the quantized weight matrices of the pre-trained large language model, outlier weight matrices of the pre-trained large language model, the adapters of the pre-trained large language model and indices of the identified outlier channels from the server; construct channel-wise scaling vectors on basis of the indices of the identified outlier channels; apply the channel-wise scaling vectors on input matrices of the pre-trained large language model to obtain scaled activation matrices; quantize the scaled activation matrices to obtain quantized activation matrices; apply the channel-wise scaling vectors on the outlier weight matrices of the pre-trained large language model to obtain scaled outlier weight matrices; quantize the scaled outlier weight matrices to obtain quantized outlier weight matrices; fine-tune the adapters of the large language model with the quantized activation matrices and the quantized outlier weight matrices; and upload the adapters of the large language model to the server.

The accelerator 220 is further configured to perform weight aggregation to produce new adapters for the large language model.

In some embodiments, one or more outlier channels are identified by: determining, for each channel of the LLM, whether data points in the channel include one or more outlier data points; and identifying the channel as an outlier channel if the data points in the corresponding channel include outlier data points.

More specifically, one or more outlier data points are data points having absolute values greater than an outlier threshold corresponding to the corresponding channel. The outlier threshold is dynamically determined on the basis of the data points in the corresponding channel.

In one embodiment, the outlier threshold is determined on the basis of an interquartile range of the data points in the corresponding channel. For example, the outlier threshold may be set to equal to 1.5 times of the interquartile range of the data points in the corresponding channel.

In another embodiment, the outlier threshold is determined on the basis of an average of absolute values of the data points in the corresponding channel. For example, the outlier threshold may be set to equal to 6 times of the average of absolute values of the data points in the corresponding channel.

The channel-wise scaling vector is constructed on the basis of the indices of the identified outlier channels by: setting a value of an entry of the channel-wise scaling vector equal to one if an index of the entry does not correspond to a position number of an outlier channel; and setting a value of an entry of the channel-wise scaling vector equal to a scaling factor if an index of the entry is corresponding to a position number of an outlier channel.

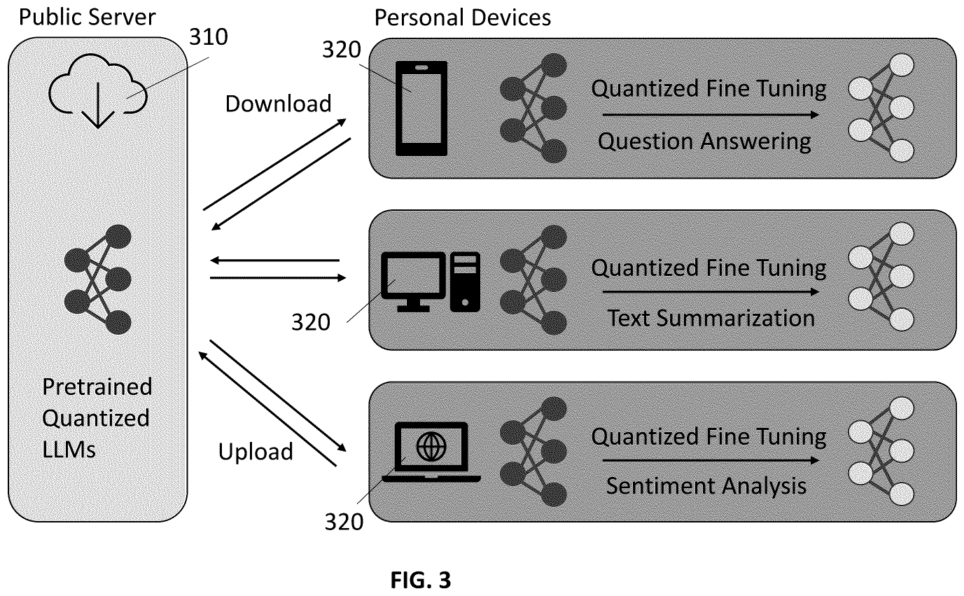

Referring to FIG. 3. In one embodiment, the LLM is collectively pretrained in a public website 310. The LLM is to be federated fine-tuned in a number of personal devices 320, each device comprises a quantization-based acceleration system for fine-tuning the LLM to perform tasks including but not limited to question answering, text summation and/or sentiment analysis.

The LLM has a plurality of channels respectively correspond to a plurality of formats for expressing semantic information (or tokens) defined under the language model. For example, an image of a cat and the word ‘cat’ is expressing two views of the same underlying concept. In this case, the image corresponds to a high bandwidth channel and the word ‘cat’ to a low bandwidth channel.

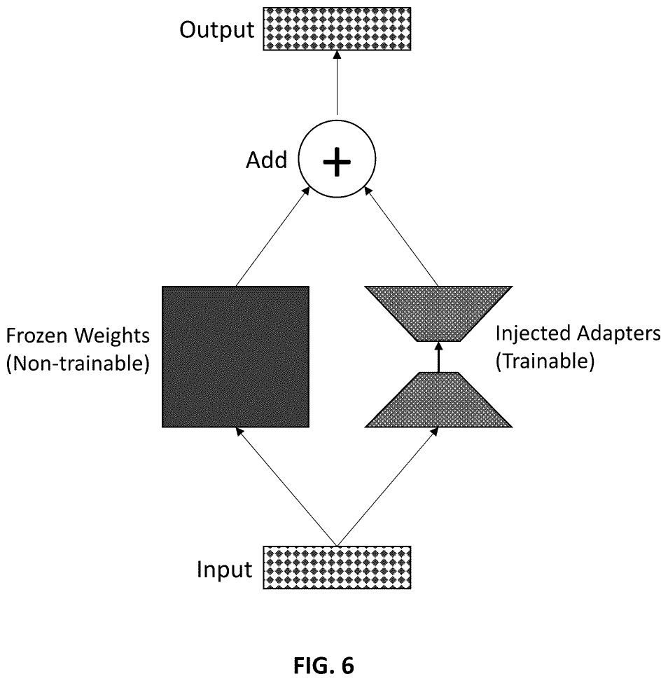

In the fine-tuning process of LLMs, most of the model parameters are frozen and will not be trained during the fine-tuning. Only a small set of injected parameters are trainable, which are called adapters. FIG. 6 shows adapters in one layer of LLMs. As a result, in the federated fine-tuning process of the LLMs, only the adapters of the LLMs are transferred between the server and the devices, leading to a substantial reduction in communication costs.

Assuming the local adapters of the LLMs are denoted as Ox for the k-th device, the device initially fine-tunes the adapters via stochastic gradient descent (SGD) as follows:

$${θ}_{k} ← {θ}_{k} - α ∇ L ( {θ}_{k} , {x}_{k} ) , \qquad ( 1 )$$

where α learning rate, xₖ stands for local confidential data, ∇L(θₖ,xₖ) signifies the gradients of the adapters θₖ. After fine-tuning, the local adapter θₖ is updated to the server which then performs aggregation on these local adapters as follows:

$$θ = \frac{1}{K} {\sum }_{k = 1}^{K} {θ}_{k} , \qquad ( 2 )$$

where the K is the number of the devices. After the aggregation process, the server broadcasts the new adapter back to the devices, who then continue to fine-tune the LLMs. This cycle repeats until convergence is achieved.

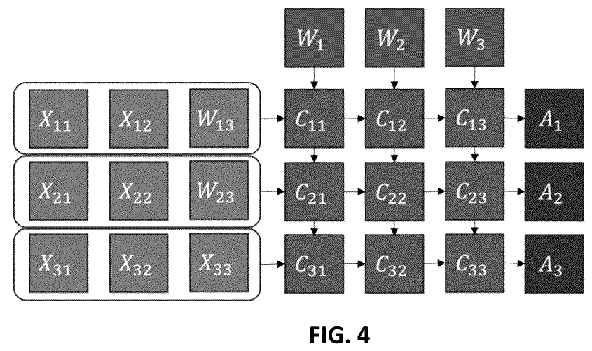

FIG. 4 shows a schematic overview of a matrix-vector multiplication A=C+b=WX+b, calculated in the quantization-based federated acceleration system (or accelerator), which constitutes a fundamental operation in the LLM, where C denotes the processing element, A is the accumulator, X∈R^{t×c}^{ᵢₙ} is the input matrix and W∈R^{c}^{ᵢₙ} in weight vector. t is the number of tokens and cᵢₙ is the number of input channels.

Firstly, the accumulators are loaded with the bias term, bₙ. After that, we load the weight values, Wₙ and the input values, X_{n,m} into the array and compute their product in the respective processing elements, C_{n,m}=X_{n,m}Wₙ in a single cycle. Last, the results will be added to the accumulators Aₙ, which are expressed as:

$${A}_{n} = {b}_{n} + {\sum }_{m} {X}_{n , m} {W}_{n} = {b}_{n} + {\sum }_{m} {C}_{n , m} . \qquad ( 3 )$$

This operation is also known as multiply-accumulate (MAC), which is a recurring process in matrix-vector multiplication tasks. During this operation, when models are trained using 32-bit floating-point precision (FP32), there's a requirement to shuttle 32-bit data from the memory to the processing units, where 32-bit calculations are then performed. Therefore, employing low bit-width matrix, such as 8-bit integers (INT8), not only reduces the volume of data needing transfer but also significantly reduces the size and energy demands of the MAC operations. This efficiency gain stems from the fact that the computational cost associated with digital arithmetic tends to increase either linearly or quadratically with the number of bits employed. Moreover, calculations performed using fixed-point arithmetic are inherently more resource-efficient than those conducted with floating-point arithmetic, further enhancing the benefits of adopting low bit-width data for these operations.

The scaling factor is computed on basis of a maximum element of the input matrix and a maximum element of the weight matrix.

In one embodiment, the channel-wise vector s E Rein is defined as:

$${s}_{i} = \{ \begin{matrix}1 & i ∉ O \\ \sqrt{max ( {X}_{, i} ) / max ( {W}_{i} )} & i ∈ O\end{matrix} , \qquad ( 4 )$$

where O is a predefined set that includes the position number of the outlier channel, X∈R^{t×c}^{ᵢₙ} is the input matrix and W∈R^{c}^{ᵢₙ}^{×c}^{ₒᵤₜ} in weight matrix. Xᵢ is the i-th column of the matrix X and Wᵢ is the i-th row of the matrix W. t is the number of tokens, cᵢₙ is the number of input channels and cₒᵤₜ is the number of output channels.

The channel-wise scaling vector s is then used to suppress the magnitude in outlier channels and convert the multiplication processing element C=XW to:

$$C = ( X {S}^{- 1} ) ( S W ) , \qquad ( 5 )$$

Where S is a diagonal matrix whose diagonal is the channel-wise vector s.

We define the scaled activation matrix as \hat{X}=XS⁻¹, which is to be quantized in real-time during fine-tuning. The scaled activation matrix X is quantized and expressed approximately as a scalar multiplied by a vector of inter values:

$$\hat{X} = {s}_{\overline{X}} \frac{\hat{X}}{{s}_{\overline{X}}} \approx {s}_{\hat{X}} [ \frac{\hat{X}}{{s}_{\hat{X}}} ] = {s}_{\hat{X}} {\hat{X}}_{int} , \qquad ( 6 )$$

where [⋅] denotes the rounding function,

$${s}_{\hat{X}} = \frac{max ( \hat{X} )}{{2}^{n} - 1}$$

∈R^{t} is the floating-point scale vector for quantizing the scaled activation matrix, n is the quantization bit width, and \hat{X}ᵢₙₜ is an integer quantized matrix, e.g. INT8, for quantizing the scaled activation matrix.

The weight matrix W is quantized and expressed approximately as a scalar multiplied by a vector of inter values:

$$W = \frac{W}{{s}_{W}} {s}_{W} \approx [ \frac{W}{{s}_{W}} ] {s}_{W} = {W}_{int} {s}_{w} , \qquad ( 7 )$$

where

$${s}_{W} = \frac{max ( W )}{{2}^{n} - 1}$$

∈R^{c}^{ₒᵤₜ} is the floating-point scale vector for quantizing the weight matrix, n is the quantization bit width, and Wᵢₙₜ is an integer quantized matrix.

The Eq. (5) is modified with Eq. (6) and (7) as follows:

$$C = \hat{X} ( S W + W - W ) = \hat{X} W + \hat{X} ( S - I ) W = \hat{X} W + {{\hat{X}}_{, O} [ ( S - I ) W ]}_{0} = \hat{X} W + {{\hat{X}}_{, O} [ ( S - I ) W ]}_{O} \approx {s}_{\hat{X}} {\hat{X}}_{int} {{W}_{int}}_{{{S}_{w} +}^{}} {\hat{X}}_{, O} {\hat{W}}_{O} , \qquad ( 8 )$$

where \hat{X}_{O} denotes the submatrix locating the outlier channels of the matrix \hat{X} and I∈R^{c}^{ᵢₙ}^{c}^{ᵢₙ} denotes the identity matrix. The third equation eliminates zero multiplication. In the above equation, we only need to requantize scaled outlier weight matrix Ŵ_{O}=[(S−I)W]_{O} in fine-tuning. Because the number of outlier channels is less than 1% compared to the whole number of channels, the quantization overhead is slight. Moreover, real-time quantization of the scaled weight matrix SW can be avoided.

The scaled outlier weight matrix Ŵ_{O} is quantized and expressed approximately as a scalar multiplied by a vector of inter values:

$${\hat{W}}_{O} = \frac{{\hat{W}}_{O}}{{s}_{{\hat{W}}_{O}}} {s}_{{\hat{W}}_{O}} \approx [ \frac{{\hat{W}}_{O}}{{s}_{{\hat{W}}_{O}}} ] {s}_{{\hat{W}}_{O}} = {\hat{W}}_{O int} {s}_{w} , \qquad ( 9 )$$

where

$${s}_{{\hat{W}}_{O}} = \frac{max ( {\hat{W}}_{O} )}{{2}^{n} - 1}$$

∈R^{c}^{ₒᵤₜ} is the floating-point scale vector for quantizing the scaled outlier weight matrix, n is the quantization bit width, and Ŵ_{O int} is an integer quantized vector, e.g. INT8, for quantizing the scaled outlier weight matrix.

The Eq. (8) is approximated with Eq. (9) as follows:

$$C \approx {s}_{\hat{X}} {\hat{X}}_{int} {W}_{int} {s}_{w} + {s}_{\hat{X}} {\hat{X}}_{, o int} {\hat{W}}_{O int} {s}_{w} , \qquad ( 10 )$$

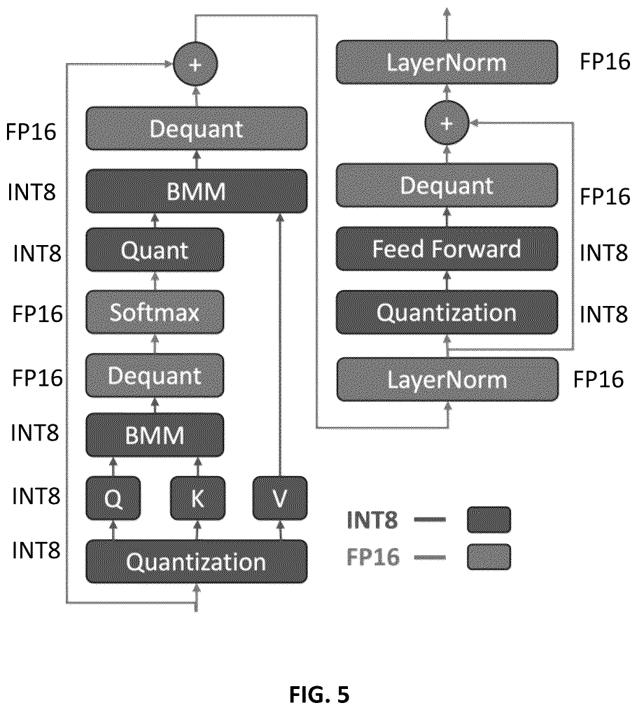

After quantization, matrix multiplication operations are applied to the quantized network parameters of the language model to obtain network outputs. FIG. 5 outlines a transformer block for performing the matrix multiplication operations in accordance with some embodiments of the present invention. In most matrix multiplication operations, like QKV projection, batched matrix multiplication (BMM), leverage low-precision computations by parameter quantization (e.g. from 16-bit floating-point precision data (FP16) to low bit-width matrix, such as 8-bit integers (INT8)), drastically reducing the number of MAC operations and memory demands for the devices.

In one embodiment, the multiplication operation is performed on the quantized activation matrix \hat{X}ᵢₙₜ and a quantized weight matrix Wᵢₙₜ to obtain a first quantized output

$${Out}_{int}^{1} ,$$

expressed as:

$${Out}_{int}^{1} = {\hat{X}}_{int} {W}_{int} , \qquad ( 11 )$$

And multiplication operation is performed on a quantized outlier activation submatrix \hat{X}_{O int}, which denotes submatrix locating the outlier channels of the quantized activation matrix \hat{X}ᵢₙₜ, and the quantized outlier weight matrix Ŵ_{O int} to obtain a second quantized output

$${Out}_{int}^{2} ,$$

expressed as:

$${Out}_{int}^{2} = {\hat{X}}_{, O int} {\hat{W}}_{O int} , \qquad ( 12 )$$

The first and second quantized outputs are then dequantized to obtain a first final prediction output

$${Out}_{fp}^{1}$$

and a second final prediction output

$${Out}_{fp}^{2} ,$$

respectively.

More specifically, the first final prediction output

$${Out}_{fp}^{1}$$

is given by:

$${Out}_{fp}^{1} = {s}_{\hat{X}} {Out}_{int}^{1} {s}_{W} , \qquad ( 13 )$$

where s_{W} is the floating-point scale factor for quantizing the weight matrix.

And the second final prediction output

$${Out}_{fp}^{2}$$

is given by:

$${Out}_{fp}^{2} = {s}_{\hat{X}} {Out}_{int}^{2} {s}_{{\hat{W}}_{O}} , \qquad ( 14 )$$

A final prediction output Out_{fp} is then obtained by adding the first final prediction output

$${Out}_{fp}^{1}$$

and the second final prediction output

$${Out}_{fp}^{2} ,$$

that is, given by:

$${Out}_{fp} = {Out}_{fp}^{1} + {Out}_{fp}^{2} , \qquad ( 15 )$$

The effectiveness of the provided system in language generation tasks using the Lambada dataset is accessed. The OPT-1.3B models are employed with the LoRA fine-tuning federated acceleration system for evaluation. The performance of the provided system is compared with LLM.int8( ) (Dettmers et al., 2022) and SmoothQuant (Xiao et al., 2023). Table 1 shows the accuracy of the OPT-1.3B model before fine-tuning and after fine-tuning.

TABLE 1
Accuracy of OPT-1.3B model before
fine-tuning and after fine-tuning

| Federated acceleration | | |
|---|---|---|
| system | Before Fine-tuning | After Fine-tuning |
| FP32 | 0.6309 | 0.7044 |
| LLM.int8( ) | 0.6154 | 0.6924 |
| SmoothQuant | 0.6227 | 0.6949 |
| Proposed System | 0.6226 | 0.7017 |

The results in Table 1 show that the provided system can achieve higher performance than previous federated acceleration systems and achieve similar accuracy to full-precision models, thanks to the specific outlier quantization procedure, which reduces the quantization error.

The efficiency of the provided system in language generation tasks using the Chip2 dataset is accessed. The LLAMA 2 7B models are employed with the LoRA fine-tuning federated acceleration system for evaluation. The performance of the provided system is compared with LLM.int8( ) (Dettmers et al., 2022) and SmoothQuant (Xiao et al., 2023). Table 2 shows the fine-tuning latency, memory footprints and the RougeL value (higher is better) after fine-tuning with the LLAMA 2 7B model.

TABLE 2
Experimental Result of the LLAMA 2 7B model

| Federated | | Memory | |
|---|---|---|---|
| acceleration | Latency (seconds | Footprints | RougeL After |
| system | per batch) | (MB) | Fine-tuning |
| FP32 | 705.3 | 40192 | 0.6533 |
| LLM.int8( ) | 714.3 | 44602 | 0.6513 |
| SmoothQuant | 388.5 | 48471 | 0.6510 |
| Proposed System | 345.9 | 27782 | 0.6532 |

The results in Table 2 show that the provided system can achieve lower latency and memory footprints, at the meantime, it can achieve higher performance than previous federated acceleration systems and achieve similar accuracy to full-precision models.

The embodiments disclosed herein may be implemented using computing devices, computer processors, or electronic circuitries including but not limited to application specific integrated circuits (ASIC), field programmable gate arrays (FPGA), microcontrollers, and other programmable logic devices configured or programmed according to the teachings of the present disclosure. Computer instructions or software codes running in computing devices, computer processors, or programmable logic devices can readily be prepared by practitioners skilled in software or electronic art based on the teachings of the present disclosure.

The embodiments may include computer storage media, transient and non-transient memory devices having computer instructions or software codes stored therein, which can be used to program or configure the computing devices, computer processors, or electronic circuitries to perform any of the processes of the present invention. The storage media, transient and non-transient memory devices can include, but are not limited to, floppy disks, optical discs, Blu-ray Disc, DVDs, CD-ROMs, and magneto-optical disks, ROMs, RAMS, flash memory devices, or any type of media or devices suitable for storing instructions, codes, and/or data.

Various embodiments of the present invention may also be implemented in distributed computing environments and/or Cloud computing environments, wherein the whole or portions of machine instructions are executed in a distributed fashion by one or more processing devices interconnected by a communication network, such as an intranet, Wide Area Network (WAN), Local Area Network (LAN), the Internet, and other forms of data transmission medium.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated.

What is claimed is:

1. A quantization-based method for federated fine-tuning a pre-trained large language model with a server and one or more devices, comprising:
(a) freezing, by the server, all weight matrices of the pre-trained language model;
(b) identifying, by the server, one or more outlier channels from a plurality of channels of the large language model on the basis of public datasets;
(c) extracting, by the server, outlier weight matrices on the basis of indices of the identified outlier channels from the frozen weight matrices of the pre-trained language model;
(d) quantizing, by the server, the frozen weight matrices of the pre-trained large language model;
(e) injecting, by the server, a set of trainable parameters into the pre-trained language model;
(f) downloading, by each device, the quantized weight matrices of the pre-trained large language model, the outlier weight matrices of the pre-trained large language model and the indices of the identified outlier channels from the server;
(g) downloading, by each device, the adapters of the pre-trained large language model;
(h) constructing, by each device, channel-wise scaling vectors on basis of the indices of the identified outlier channels;
(i) applying, by each device, the channel-wise scaling vectors on input matrices of the pre-trained large language model to obtain scaled activation matrices;
(j) quantizing, by each device, the scaled activation matrices to obtain quantized activation matrices;
(k) applying, by each device, the channel-wise scaling vectors on the outlier weight matrices of the pre-trained large language model to obtain scaled outlier weight matrices;
(l) quantizing, by each device, the scaled outlier weight matrices to obtain quantized outlier weight matrices;
(m) fine-tuning, by each device, the adapters of the large language model with the quantized activation matrices and the quantized outlier weight matrices;
(n) uploading, by each device, the adapters of the large language model to the server;
(o) performing, by the server, weight aggregation to produce new adapters for the large language model;
(p) repeating steps (g) to (o) until a stop criterion is met.

2. The quantization-based method according to claim 1, wherein one or more outlier channels are identified by:
determining, for each channel of the large language model, whether data points in the channel include one or more outlier data points; and
identifying the channel as an outlier channel if the data points in the corresponding channel include outlier data points.

3. The quantization-based method according to claim 2, wherein one or more outlier data points are data points having absolute values greater than an outlier threshold corresponding to the corresponding channel.

4. The quantization-based method according to claim 3, wherein the outlier threshold is dynamically determined on the basis of the data points in the corresponding channel.

5. The quantization-based method according to claim 4, wherein the outlier threshold is determined on the basis of an interquartile range of the data points in the corresponding channel.

6. The quantization-based method according to claim 4, wherein the outlier threshold is determined on the basis of an average of absolute values of the data points in the corresponding channel.

7. The quantization-based method according to claim 1, wherein the channel-wise scaling vector is constructed on basis of the indices of the identified outlier channels by:
setting a value of an entry of the channel-wise scaling vector equal to one if an index of the entry does not correspond to a position number of an outlier channel; and
setting a value of an entry of the channel-wise scaling vector equal to a scaling factor if an index of the entry corresponds to a position number of an outlier channel.

8. The quantization-based method according to claim 1, wherein the scaling factor is computed on the basis of a maximum element of the input matrix and a maximum element of the weight matrix.

9. The quantization-based method according to claim 1, wherein the plurality of channels respectively correspond to plurality formats for expressing semantic information defined under the large language model.

10. The quantization-based method according to claim 9, wherein the large language model is fine-tuned for question answering, text summation and/or sentiment analysis.

11. A quantization-based system for federated fine-tuning a pre-trained large language model, comprises:
a memory configured to store the large language model and input matrices;
an accelerator configured to:
freeze all weight matrices of the pre-trained language model;
identify one or more outlier channels from a plurality of channels of the large language model on the basis of public datasets;
extract outlier weight matrices on the basis of indices of the identified outlier channels from the frozen weight matrices of the pre-trained language model;
quantize the frozen weight matrices of the pre-trained large language model; and
inject a set of adapters into the pre-trained language model; and
one or more local devices, each device is configured to:
download the quantized weight matrices of the pre-trained large language model, outlier weight matrices of the pre-trained large language model, the adapters of the pre-trained large language model and the indices of the identified outlier channels from the server;
construct channel-wise scaling vectors on basis of the indices of the identified outlier channels;
apply the channel-wise scaling vectors on input matrices of the pre-trained large language model to obtain scaled activation matrices;
quantize the scaled activation matrices to obtain quantized activation matrices;
apply the channel-wise scaling vectors on the outlier weight matrices of the pre-trained large language model to obtain scaled outlier weight matrices;
quantize the scaled outlier weight matrices to obtain quantized outlier weight matrices;
fine-tune the adapters of the large language model with the quantized activation matrices and the quantized outlier weight matrices; and
upload the adapters of the large language model to the server; and
wherein the server is further configured to perform weight aggregation to produce new adapters for the large language model.

12. The quantization-based system according to claim 11, wherein one or more outlier channels are identified by:
determining, for each channel of the large language model, whether data points in the channel include one or more outlier data points; and
identifying the channel as an outlier channel if the data points in the corresponding channel include outlier data points.

13. The quantization-based system according to claim 12, wherein one or more outlier data points are data points having absolute values greater than an outlier threshold corresponding to the corresponding channel.

14. The quantization-based system according to claim 13, wherein the outlier threshold is dynamically determined on the basis of the data points in the corresponding channel.

15. The quantization-based system according to claim 14, wherein the outlier threshold is determined on the basis of an interquartile range of the data points in the corresponding channel.

16. The quantization-based system according to claim 14, wherein the outlier threshold is determined on the basis of an average of absolute values of the data points in the corresponding channel.

17. The quantization-based system according to claim 11, wherein the channel-wise scaling vector is constructed on basis of the indices of the identified outlier channels by:
setting a value of an entry of the channel-wise scaling vector equal to one if an index of the entry corresponds to a position number of an outlier channel; and
setting a value of an entry of the channel-wise scaling vector equal to a scaling factor if an index of the entry does not correspond to a position number of an outlier channel.

18. The quantization-based system according to claim 11, wherein the scaling factor is computed on the basis of a maximum element of the input matrix and a maximum element of the weight matrix.

19. The quantization-based system according to claim 11, wherein the plurality of channels respectively correspond to a plurality of formats for expressing semantic information defined under the large language model.

20. The quantization-based system according to claim 19, wherein the large language model is fine-tuned for question answering, text summation and/or sentiment analysis.
